(19) United States
(12) Patent Application Publication
(10) Pub. No.: US 2018/0139506 A1
(43) Pub. Date: May 17, 2018

(54) SYSTEM AND METHOD FOR DIGITAL TELEVISION NOTIFICATION SERVICE

(71) Applicants: Jamdeo Canada Ltd., Oakville (CA); Hisense Electric Co., Ltd., Qingdao (CA); Hisense USA CORP., Suwanee, GA (US); Hisense International Co., Ltd., Qingdao (CN)

(72) Inventors: Eduardo Diego TORRES MILANO, Oakville (CA); Ran HUANG, Oakville (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/349,815

(22) Filed: Nov. 11, 2016

(51) Int. Cl. H04N 21/488; H04N 21/61; H04N 21/431; H04N 21/81

(52) U.S. Cl. CPC H04N 21/4882; H04N 21/6125; H04L 67/26; H04N 21/8166; H04N 21/4312

(57) ABSTRACT

The present disclosure relates to electronic devices, processes and systems for presentations of notifications by a digital television. In one embodiment, a method for presentation of notifications includes running, by a digital television, a notifications service, wherein the notification service provides an architecture for exchange and encapsulation of notification objects with respect to applications and components of the digital television, querying by a notifications controller of the notifications service one or more notification clients, and receiving, by the notification controller, a notification object from the notifications client, wherein the notification object includes data for implementation of the notification and content of the notification object. The method also includes outputting, by the notification controller, a population command for the notification object; and presenting, by the digital television, the notification object based on the data for implementation and the content of the notification object.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for communication and exchange of data relative to the applications and television components. In particular, there exists a need for programs and configurations that allow for features of the applications to be presented on a digital television. While execution of an application and application interfaces exist for digital televisions, there exists a need for communication between television components and the applications to allow for application features to be presented with or in addition to television features. Accordingly, there exists a need for processes and configurations to improve digital television operation.

### BRIEF SUMMARY OF THE EMBODIMENTS

Disclosed and claimed herein are methods, devices and systems for presentation of notifications by a digital television. One embodiment is directed to a method including running, by a digital television, a notifications service, wherein the notification service provides an architecture for exchange and encapsulation of notification objects with respect to applications and components of the digital television, querying by a notifications controller of the notifications service one or more notification clients, and receiving, by the notification controller, a notification object from the notifications client, wherein the notification object includes data for implementation of the notification and content of the notification object. The method also includes outputting, by the notification controller, a population command for the notification object, and presenting, by the digital television, the notification object based on the data for implementation and the content of the notification object.

In one embodiment, the notification service is a program run as a background process by the digital television interacting with applications executed by the digital television and digital television system components.

In one embodiment, notification clients include applications executed by the digital television and digital television system components.

In one embodiment, the one or more notification clients include a cloud service configured to push notifications to the digital television by way of a communications network.

In one embodiment, the notification object includes a display message for one or more of a message notification, content alert, system update, system requirement, menu element presentation and display element in general of the digital television.

In one embodiment, the population command is generated by the notifications controller to include the notification object in a current display of the digital television.

In one embodiment, presentation of the notification object includes display of a toast element by the digital television.

In one embodiment, presentation of the notification object includes display of a menu element within a menu presented by the digital television.

In one embodiment, the method also includes receiving one or more values associated with the presentation configuration of the digital television by the notification controller and outputting the population command based on the one or more values associated with the presentation configuration of the digital television.

In one embodiment, the method also includes receiving ticks from a timer service of the digital television for timed presentation of the notification.

In one embodiment, the method also includes obtaining one or more notification objects from a notification database based on ticks received from the timer service and values associated with the presentation configuration of the digital television.

Another embodiment is directed to a digital television including a display and a controller coupled to the display. The controller configured to run a notifications service, wherein the notification service provides an architecture for exchange and encapsulation of notification objects with respect to applications and components of the digital television, control querying by a notifications controller of the notifications service one or more notification clients, and control receiving, by the notification controller, a notification object from the notifications client, wherein the notification object includes data for implementation of the notification and content of the notification object. The controller also configured to control outputting, by the notification controller, a population command for the notification object, and control presenting, by the digital television, the notification object based on the data for implementation and the content of the notification object.

Another embodiment is directed to method for presentation of notifications by a digital television. The method includes running, by a digital television, a notifications service, wherein the notification service provides an architecture for exchange and encapsulation of notification objects with respect to applications and components of the digital television, and receiving, by the notification controller, a notification object from a notifications client, wherein the notification object includes data for implementation of the notification and content of the notification object. The method also includes presenting, by the digital television, the notification object based on the data for implementation and the content of the notification object and detecting, by the digital television, selection of the notification object. The method also includes transmitting, by the digital television, an indication of the selection of the notification to a cloud server.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIGS. 1A-1B depict graphical representations of notification object presentation according to one or more embodiments;

FIG. 2 depicts a process for presentation of notifications according to one or more embodiments;

FIG. 3 depicts a graphical representation of a notification service according to one or more embodiments;

FIG. 4 depicts a simplified system diagram of a digital television according to one or more embodiments;

FIG. 5 depicts a graphical representation of notification service operation according to one or more embodiments;

FIG. 6 depicts a graphical representation of notification controller operation according to one or more embodiments;

FIG. 7 depicts a graphical representation of notification object presentation according to one or more embodiments;

FIG. 8 depicts a notification object class diagram according to one or more embodiments;

FIG. 9 depicts a graphical representation of a system according to one or more embodiments;

FIG. 10 depicts a process for notification tracking according to one or more embodiments;

FIG. 11A depicts a graphical representation of notification publishing according to one or more embodiments; and

FIG. 11B depicts a graphical representation of notification analytics according to one or more embodiments.

### DETAILED DESCRIPTION OF THE EXEMPLARY EMBODIMENTS

### Overview and Terminology

One aspect of the disclosure relates to providing a system and framework for exchange and presentation of notifications with a digital television. In particular, digital televisions that are configured to run television system components and execute applications. In one embodiment, notification service is provided. The notification service can provide an architecture and system for presentation of notifications by a digital television. With advancements in digital television technology and the addition of applications and features into digital television sets, the notification service provides configurations to exchange of notifications within the digital television and presentation of notifications, or notification objects. According to another embodiment, the notifications may be presented as part of graphical elements of the digital television, such as menus, launcher bars, etc. In that fashion, the notification service allows for notifications to be integrated with digital television operating configurations and allows for applications and application content to be provided with particular device control interfaces.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

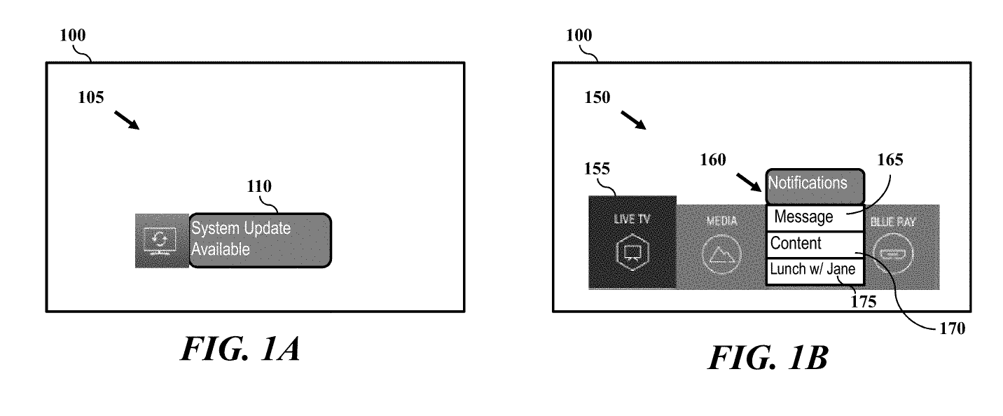

Referring now to the figures, FIGS. 1A-1B depict graphical representations of notification object presentation. According to one embodiment, a digital television 100 is configured to run a notifications service, which provides an architecture for processing, exchange and presentation of notification objects relative to applications and system elements of digital television 100. According to one embodiment, notifications may be presented to alert users of a digital television with respect to television operation, application functions and/or communication messages associated with the digital television. FIGS. 1A-1B depict exemplary representations of notifications.

In FIG. 1A, digital television 100 presents a display configuration 105 including notification 110. According to one embodiment, notification 110 relates to a graphical element displayed in a position of a display to provide an alert associated with one or more of television operation, application functions and/or communication messages. According to one embodiment notification 110 relates to a toast presented by an application executed by the digital television. According to another embodiment, notification 110 relates to a message associated with system operation of the digital television. According to another embodiment, notification 110 relates to an alert associated with content available to digital television 100. In another embodiment, notification 110 relates to a message or alert associated with digital television 100 communication and/or interoperation with other devices (e.g., companion devices, set top boxes, personal communication devices, etc.).

According to one embodiment, presentation of notification 110 may be based on and controlled by operations of a notifications service. According to another embodiment, presentation of notifications by digital television 100, such as notification 110, may be based on notification architecture.

FIG. 1A depicts presentation of notification 110 as a graphical display element which may be an overlay to display content of digital television 100. According to another embodiment, presentation of notifications may be in conjunction with and/or incorporation with graphical control features of a digital television.

Referring now to FIG. 1B, digital television 100 presents a display configuration 150 including a graphical control interface of the digital television, menu bar 155. According to one embodiment, a notification system run by digital television 100 is configured to present menu bar 155 including a plurality of control elements and one or more notifications. In FIG. 1B, menu bar 155 includes tab 160 with a plurality of notifications, notification 165, notification 170 and notification 175. According to one embodiment notifications presented in menu bar 155 may be associated with one or more applications and/or sources of the digital television 100. According to an exemplary embodiment, notification 165 related to a notification associated with a message available and/or accessible by digital television 100. Notification 170 relates to content accessible to digital television 100, such as video content, images, video on demand, etc. Notification 175 can relate to a reminder of calendaring notification generated by an application executed by the device or companion device to digital television 100.

According to one embodiment, presentation of notification 165, notification 170 and notification 175 may be based on and controlled by operations of a notifications service run by digital television 100. According to another embodiment, presentation of notifications by digital television 100 may be based on a notification architecture described herein.

As will be discussed in more detail below, a notifications service and notification architecture can provide content to applications and can allow for data encapsulation to allow for notification sharing among applications of the digital television.

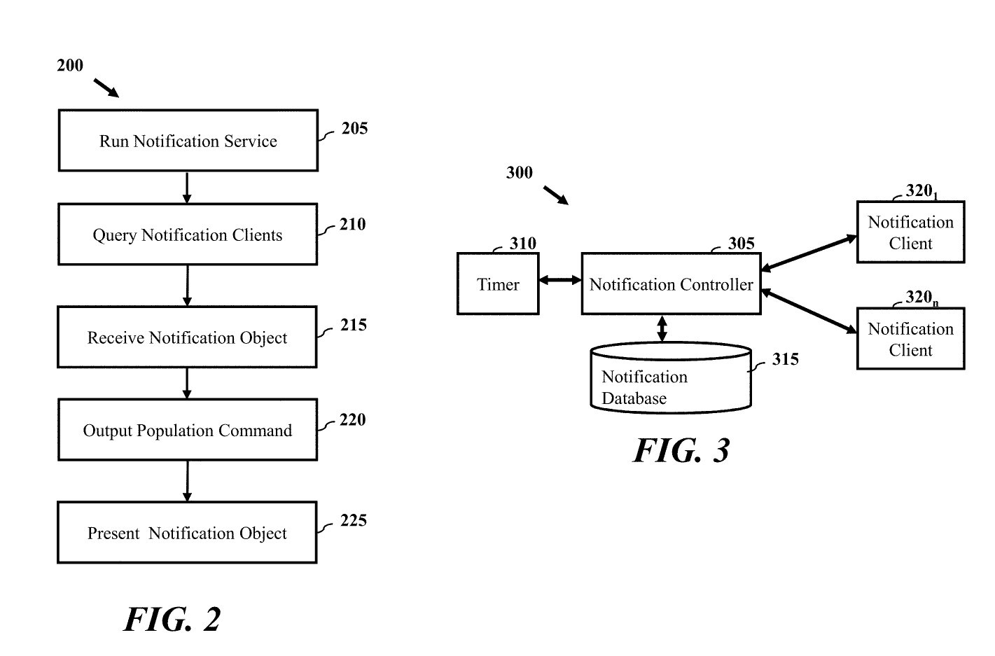

FIG. 2 depicts a process for presentation of notifications according to one or more embodiments. Process 200 may be employed to present one or more notifications by a digital television (e.g., digital television 100). By way of example, process 200 may be employed to present notifications associated with one or more applications run by the digital television. Alternatively, or in combination, process 200 may be performed by a digital television to present notifications associated with operational software and components of the digital television itself.

Process 200 may be initiated by running a notification service at block 205. In one embodiment, the notification service provides an architecture for exchange and encapsulation of notification objects with respect to applications and components of the digital television. According to another embodiment, the notification service is a program run as a background process by the digital television interacting with applications executed by the digital television and digital television system components. In one embodiment, the notification service is run at startup of the digital television and runs until the digital television is powered down.

At block 210, a notifications controller of the notifications service queries one or more notification clients. As will be discussed in more detail with FIG. 3 for example, the notification service allows for notification objects to be handled from a plurality of clients (e.g., applications, TV components, other devices, etc.). The notification objects may be process, handled and exchanged by the notification service to allow for presentation of a notification as a graphical element by the digital television.

At block 215, the notification controller receives a notification object from a notifications client. In one embodiment, a notification client includes applications executed by the digital television and digital television system components. The notification object includes data for implementation of the notification and content of the notification object. In one embodiment, the notification object includes a display message for one or more of a message notification, content alert, system update, system requirement, menu element presentation and display element in general of the digital television.

At block 220, the notification controller outputs a population command for the notification object. In one embodiment, the population command is generated by the notifications controller to include the notification object in a current display of the digital television. In one embodiment, process 200 also includes receiving one or more values associated with the presentation configuration of the digital television by the notification controller and outputting the population command based on the one or more values associated with the presentation configuration of the digital television.

At block 225, the digital television presents the notification object based on the data for implementation and the content of the notification object. In one embodiment, presentation of the notification object includes display of a toast element by the digital television. According to another embodiment, presentation of the notification object includes display of a menu element within a menu presented by the digital television.

According to another embodiment, presentation of the notification may be based on a particular presentation format of the digital television or based on time of operation. In one embodiment, process 200 includes receiving ticks from a timer service of the digital television for timed presentation of the notification. According to another embodiment, process 200 includes obtaining one or more notification objects from a notification database based on ticks received from the timer service and values associated with the presentation configuration of the digital television.

FIG. 3 depicts a graphical representation of a notification service according to one or more embodiments. Notification service 300 may relate to a background program executed by a digital television, such a processor of the digital television. Notification service 300 allows for content to be provided to applications, from one or more notification clients.

According to one embodiment, a notification service 300 includes a notification controller 305. Notification controller 305 receives ticks from timer service 310 to process and enable time notifications. Notification controller 305 received notifications published from notification clients 320₁₋ₙ and can request notifications from 320₁₋ₙ. According to one embodiment, notification clients 320₁₋ₙ represent applications executed by a digital television and components of the digital television (e.g., digital television hardware which may generated system commands, graphical elements, etc.). By handling application and digital television elements as notification clients 320₁₋ₙ, notification controller 305 can allow for exchange and presentation of notifications based on a time, configuration format of the display, availability of content from application, etc.

According to one embodiment, notification controller 305 and notification service 300 operate based on a coordinated set of constraints applied to the notifications. In one embodiment, notifications are formatted based on or similar to a REST (Representation State Transfer) software style. According to another embodiment, notifications may be transmitted and communicated based on a network websocket architecture and/or bi-directional web communication and connection management.

Notification database 315 allows for notifications received from notification clients 320₁₋ₙ to be stored and presented at a future or later time. By way of example, notification client 320₁ may publish a notification object to alert content availability, such as a new title available for presentation in a menu bar. If the menu bar is not presented, the notification service may store the notification object in notification database 315. Moreover, the notification controller 305 may delay presentation of the notification until one or more of the menu bar is presented, a particular menu bar tab is selected, an application is launched, and/or a time value matches a presentation capability of the content. In one embodiment, notifications may be presented associated with a time period (e.g., calendar, time of day, etc.) such that notifications may not be relevant after expiration of the time period. Thus, notification controller 305 receives ticks from timer service 310 of the digital television for timed presentation of the notification and/or to prevent notification when a time period for a particular notification object has expired.

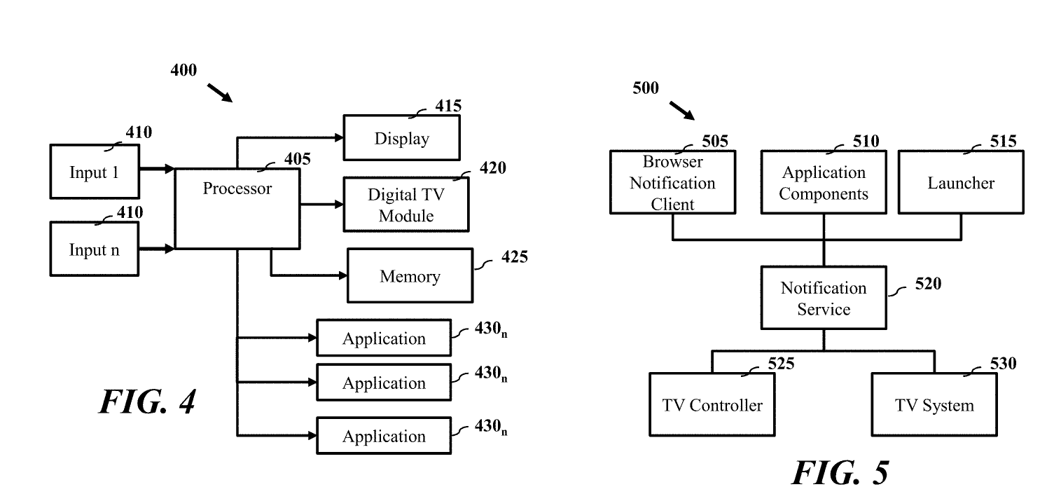

FIG. 4 depicts a simplified system diagram of a digital television according to one or more embodiments. Digital television 400 includes processor 405, inputs 410, display 415, digital TV module 420, memory 425, and applications 430. It should be appreciated that digital television 400 may include one or more additional components not shown in FIG. 4. Digital television 400 is configured to present notifications using a notification service as described herein.

Inputs 410 relate to physical inputs for receiving video/image content and/or network data for presentation of content on display 415. Digital TV module 420 includes decoder/converter elements to receive information and content from inputs 410 which is then formatted and output to processor 405 for presentation on display 415. Memory 425 may include ROM and RAM memory for operation of digital television 400 and processor 405.

FIG. 5 depicts a graphical representation of notification service operation according to one or more embodiments. According to one embodiment, applications and elements of the digital television can send notifications using the notification service. FIG. 5 depicts an exemplary representation of the digital television components and notification clients relative to notification service 500. According to an exemplary embodiment, browser notification client 505, application components 510 and launcher (e.g., menu interface) 525 may send notifications by way of notification service 520 to each other or elements of the digital television, such as TV controller 525 (e.g., processor 405) and TV system 530 (e.g., TV operating system). Notification service 520 is configured to determine whether notification objects persist or expire prior to presentation. According to another embodiment, notification service 520 handles notification objects associated with TV controller 525 and TV system 530, such as notifications for TV software updates.

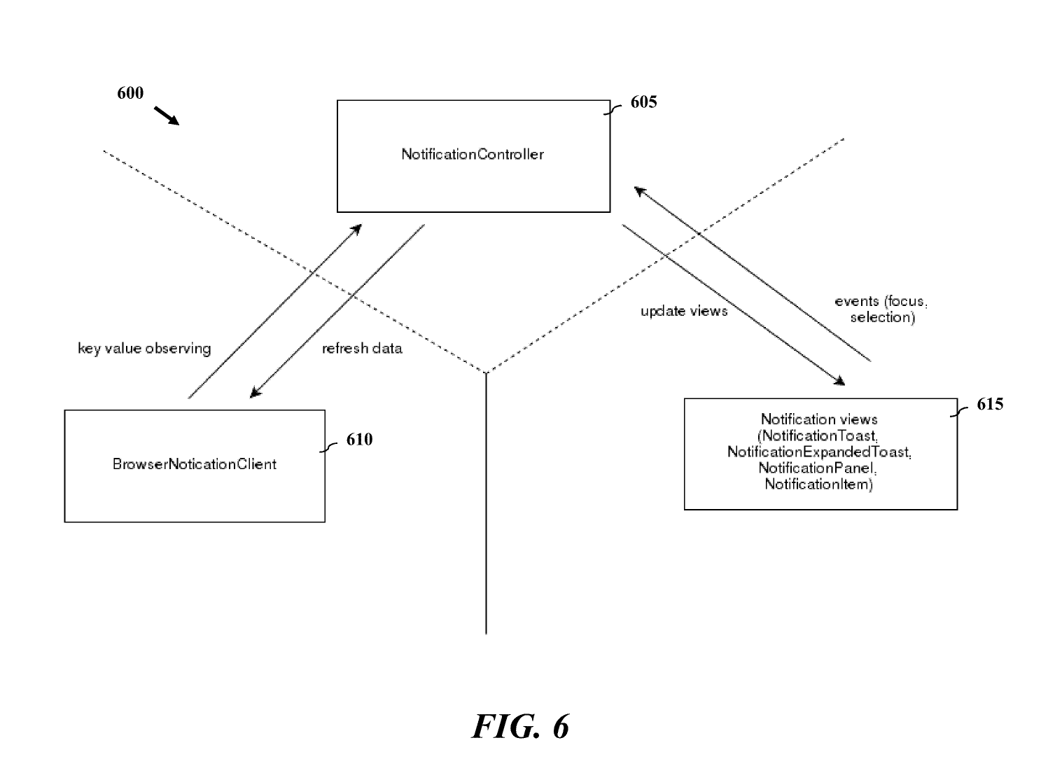

FIG. 6 depicts a graphical representation of notification controller operation according to one or more embodiments. Process 600 represents an exemplary depiction of operation between a notification control 605 of a notifications service, such as browser notification client 610, a notification client and notification views 615. Browser notification client 610 is an example of a notification client (e.g., notification client 320₁) which runs in the context of the browser container of the digital television (e.g., television browser application). According to one embodiment, browser notification client 610 serves as the model layer in the notifications mechanism. In addition to keeping the notifications data in sync with a notification service, other components can register with browser notification client 610 using a callback, using a Key-Value-Observing pattern. Thus, a change in the model data will notify the notification control 605 which in turn will query browser notification client 610 and populate the notification views 615 (e.g., notification toast, notification panel). The browser notification client 610 will therefore need to have the ability to access a persistence layer in which to store notifications data that is able to persist across reboots of the digital television. Browser notification client 610 depends on the notification service for data and the digital television publishes notifications. As can be seen in FIG. 6, the notification control 605 acts as a controller and browser notification client 610 is an exemplary notification client, and the visible elements such a notification toast, or notification panel, are notification views 615. This arrangement ensures that notification views 615 are always in sync with the underlying data and the model is able to notify the controller of changes in the model using the observer pattern.

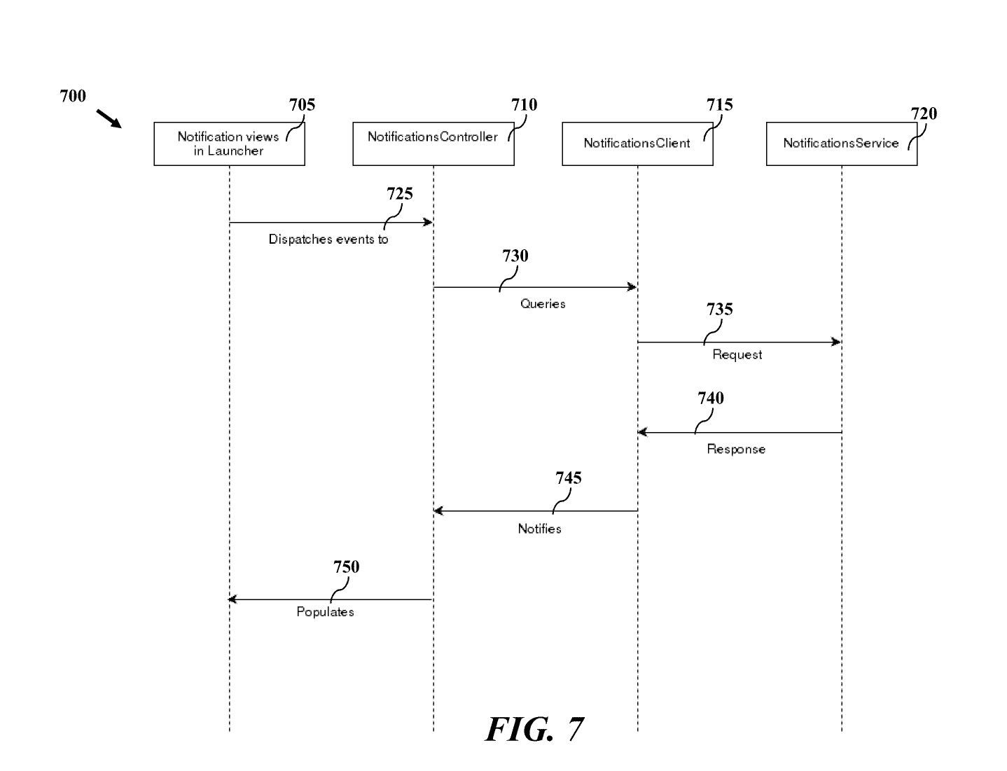

FIG. 7 depicts a graphical representation of notification object presentation according to one or more embodiments. Process 700 describes an exemplary process for rendering notification views by a notification service of a digital television. Process 700 is depicted relative to changes in the view of a digital television. According to one embodiment, a notifications service monitors changes in the layout, presentation, input and content of a display. Accordingly, based on the notification views generated by a notification client/TV system, format and population of notifications can be presented. Process 700 is initiated by notification views in a launcher 705 dispatched events 725 to notifications controller 710. Events may include changes in tab selected of a menu, initiation of display, navigation within the menu, search terms, etc. Based on dispatched events 725, notification controller 710 can issue a query/queries to notifications client 715 (e.g., applications, the TV system, etc.) for relevant notification objects. Notifications client 715 may then request notifications 735 from notifications service 720. According to one embodiment, notifications service 720 provides response 740 with a notification object in response to request 735 to notifications client 715.

Based on response 740, notifications client 715 provides notification 745 to notification controller 710 which determined whether to output the notification object. Notification controller 710 outputs population command 750 to launcher 705.

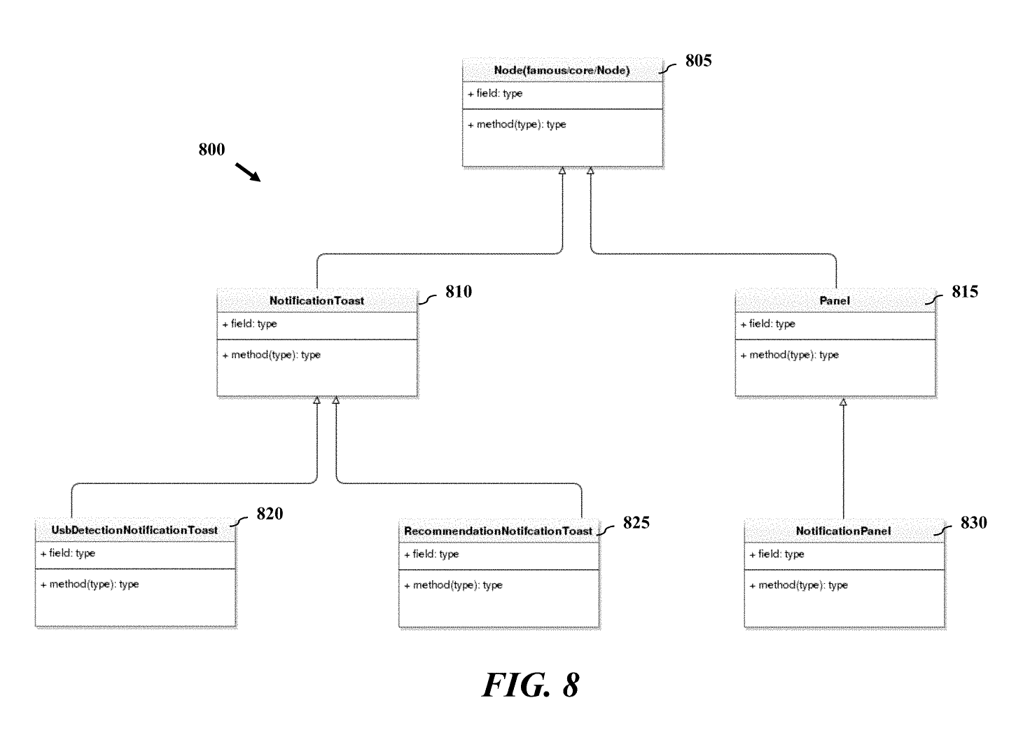

FIG. 8 depicts a notification object class diagram according to one or more embodiments. Class diagram 800 depicts how properties and behavior of notification views. According to one embodiment, notifications objects can be formatted base on type and method of presentation. For example, a notification object may be formatted for a particular type of display, such that the particular notification object is presented as a toast or within a menu bar/launcher. Alternatively, or in combination, the notification object may be current display configuration may configure how the notification object is presented.

In FIG. 8, notification model 800 includes characterization of all notification objects with a core elements 805. Notification objects may then be classified as either a notification toast 810 (see FIG. 1A) or panel notification 815 (see FIG. 1B). Notification objects associated with notification toast 810 may be further classified by type such as a system notification for detection of a USB port notification 820 or recommended content notification 825. Notification objects associated with panel notification 815 may be further classified by type such as a panel notification 830.

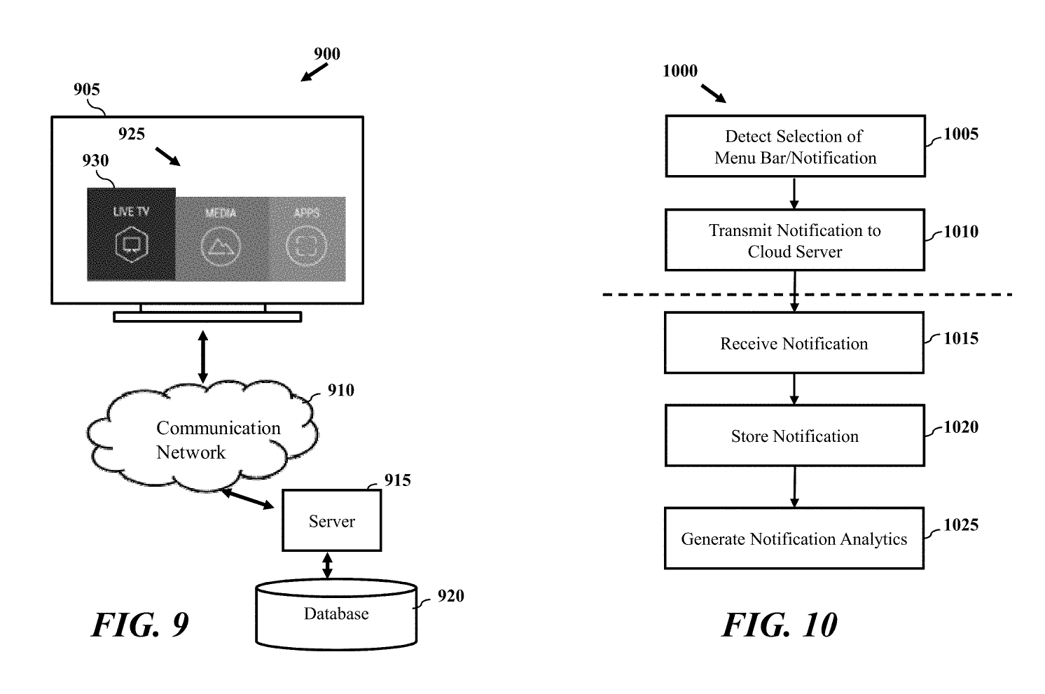

FIG. 9 depicts a graphical representation of a system according to one or more embodiments. According to one embodiment, notifications may be configured for network (e.g., cloud service, etc.) delivery to a digital television. In addition, the notification architecture may be employed for messaging a network server with respect to interactions within the digital television. System 900 includes digital television 905 configured to communication with server 915 by way of communication network 910. Database 920 may be configured to store notifications, and analytics with respect to selection of elements of a menu bar and/or notification presented by digital televisions.

According to one embodiment, digital television 905 may be configured to present notifications pushed to the device from a cloud service, such as server 915. In one embodiment, cloud notifications are formatted to allow for one or more cloud servers to push notifications to digital televisions. According to another embodiment, system 900 allows for devices to submit analytical data to the cloud.

According to one embodiment, user interface 925 includes presentation of a menu bar including one or more tab elements, such as tab element 930. According to one embodiment, a digital television may track selections of the user interface 925 and transmit messages to a server, such as a cloud server, to store analytics for usage with respect to menu bar elements.

FIG. 10 depicts a process for notification tracking according to one or more embodiments. According to one embodiment, notification presentation and interaction may be tracked for analyzing menu bar use and/or presentation of elements in a menu bar.

Process 1000 can allow for submitting analytical information to a network server (e..g, cloud server, etc.). At block 1005, selection of menu bar/notification (e.g., tab element 930, etc.) may be detected by a digital television according to one or more embodiments. In one embodiment, this selection may be in response to content presented on a digital television. Selections of the user interface may be based on content received by the digital television, such as a notification object from a notifications client, wherein the notification object includes data for implementation of the notification and content of the notification object. According to another embodiment, indications of interface selections may be in response to one or more notification objects based on the data for implementation and the content of the notification object. At block 1010, an indication of the selection of the menu bar/notification may be transmitted by the digital television to a cloud server. The indication of the selection of the notification may be transmitted with the format of a notification object to the cloud server Blocks 1005 and 1010 represent operations by a digital television. Blocks 1015, 1020 and 1025 of FIG. 10 represent operations of a cloud server.

The notification transmitted at block 1010 is received at block 1015 by the cloud server and the indication of the notification selection is stored at block 1020.

Notification analytics may be generated at block 1025 based on interaction with the digital television including selection of notifications.

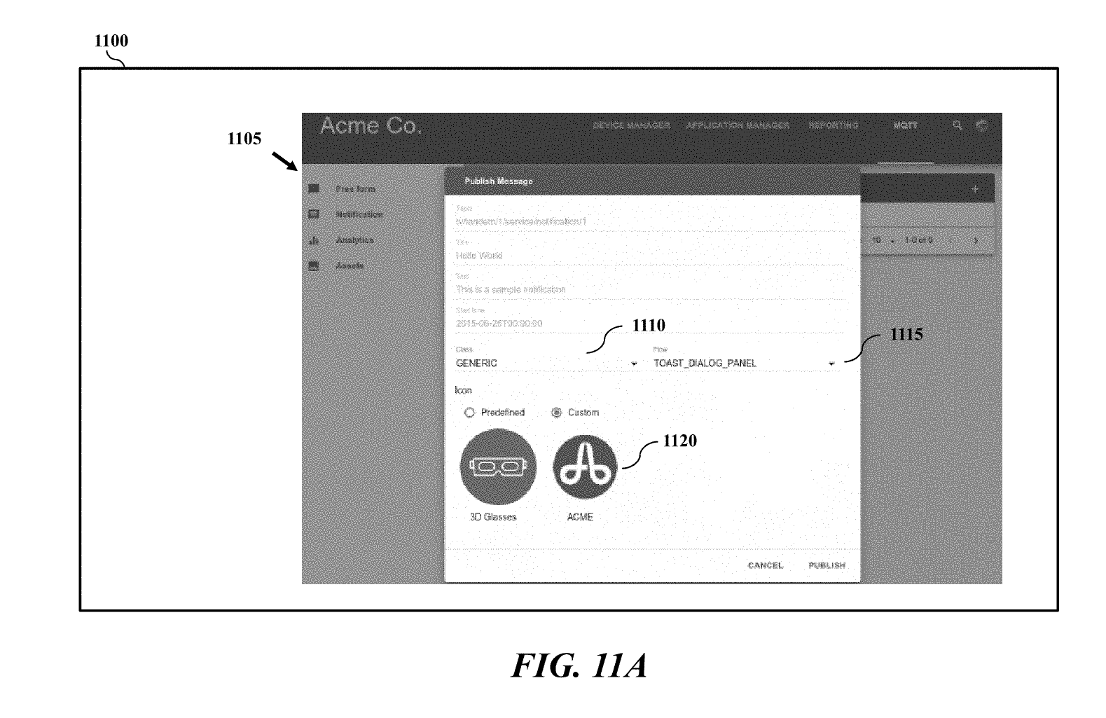

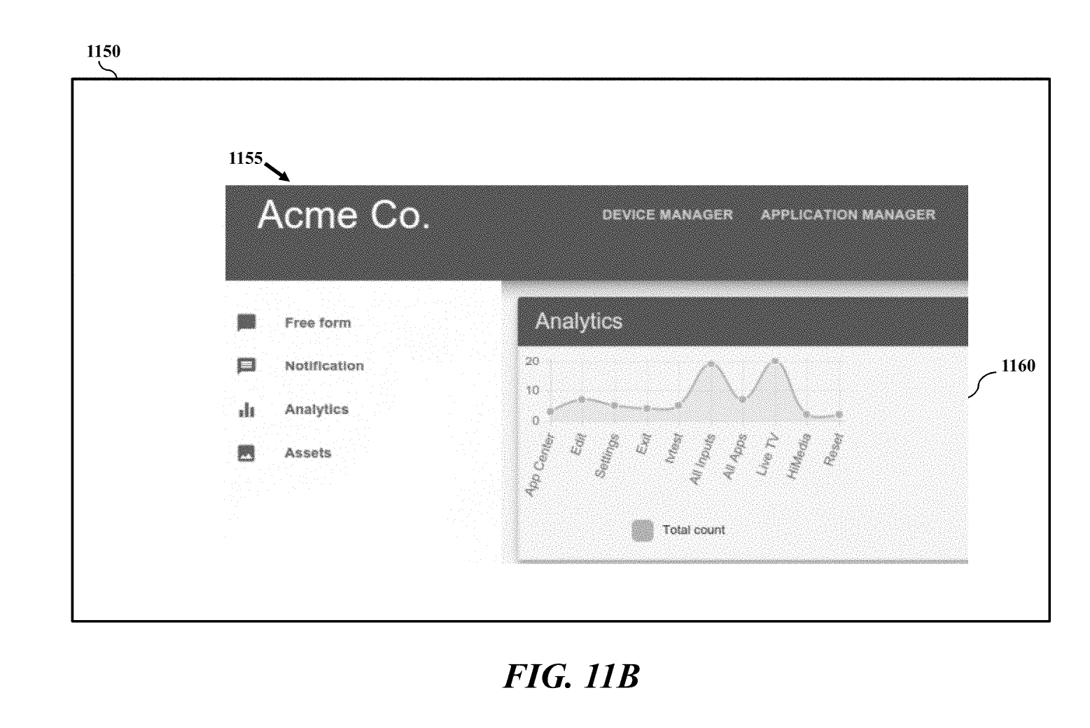

FIG. 11A depicts a graphical representation of notification publishing according to one or more embodiments. According to one embodiment, a network server (e.g., cloud server) may be accessed and/or utilized to configure and push notifications from a network server to one or more devices. In one embodiment, the notification can be configured using a web interface. FIG. 11A depicts display 1100 of a computing device presenting interface 1105. According to one embodiment, interface 1105 may allow for configuration of notifications using a web interface. Interface 1105, for example, includes elements 1110 to set notification attributes client, elements 1115 to define a notification type, and display attributes such as a notification icon/image 1120. A server may be accessed to configure and push notifications from a network server to a digital television based on notification attributes selected with interface 1105. .

FIG. 11B depicts a graphical representation of notification analytics according to one or more embodiments. According to one embodiment, based on interaction with a digital television, one or more notification services interactions may be tracked and analyzed by a network server to present notification analytics. Analytics may be based on communications generated by digital televisions to a cloud server. Display 1150 of a computing device includes presentation of display interface 1155 associated with data collected by a network service (e.g., cloud service). In one exemplary embodiment, analytic display 1160 represents the number of views or selections of notifications.

While this disclosure has been particularly shown and described with references to exemplary embodiments thereof, it will be understood by those skilled in the art that various changes in form and details may be made therein without departing from the scope of the claimed embodiments.

1. A method for presentation of notifications by a digital television, the method comprising:
running, by a digital television, a notifications service, wherein the notification service provides an architecture for exchange and encapsulation of notification objects with respect to applications and components of the digital television;
querying by a notifications controller of the notifications service one or more notification clients;
receiving, by the notification controller, a notification object from the notifications client, wherein the notification object includes data for implementation of the notification and content of the notification object;
outputting, by the notification controller, a population command to the digital television for the notification object, wherein the population command is generated by the notifications controller to include the notification object in a current display of the digital television; and
presenting, by the digital television, the notification object based on the data for implementation and the content of the notification object.

2. The method of claim 1, wherein the notification service is a program run as a background process by the digital television interacting with applications executed by the digital television and digital television system components.

3. The method of claim 1, wherein notification clients include applications executed by the digital television and digital television system components.

4. The method of claim 1, wherein one or more notification clients includes a cloud service configured to push notifications to the digital television by way of a communications network.

5. The method of claim 1, wherein the notification object includes a display message for one or more of a message notification, content alert, system update, system requirement, menu element presentation and display element in general of the digital television.

6. The method of claim 1, wherein the notifications service monitors changes in the layout, presentation, input and content of a display of the digital television the notification controller issues a query to the notifications client for relevant notification objects based on the changes.

7. The method of claim 1, wherein presentation of the notification object includes display of a toast element by the digital television.

8. The method of claim 1, wherein presentation of the notification object includes display of a menu element within a menu presented by the digital television.

9. The method of claim 1, further comprising receiving one or more values associated with the presentation configuration of the digital television by the notification controller and outputting the population command based on the one or more values associated with the presentation configuration of the digital television.

10. The method of claim 1, further comprising receiving ticks from a timer service of the digital television for timed presentation of the notification.

11. The method of claim 9, further comprising obtaining one or more notification objects from a notification database based on ticks received from the timer service and values associated with the presentation configuration of the digital television.

12. A digital television comprising:
a display;
a controller coupled to the display, the controller configured to
run a notifications service, wherein the notification service provides an architecture for exchange and encapsulation of notification objects with respect to applications and components of the digital television;
control querying by a notifications controller of the notifications service one or more notification clients;
control receiving, by the notification controller, a notification object from the notifications client, wherein the notification object includes data for implementation of the notification and content of the notification object;
control outputting, by the notification controller, a population command to the digital television for the notification object, wherein the population command is generated by the notifications controller to include the notification object in a current display of the digital television; and
control presenting, by the digital television, the notification object based on the data for implementation and the content of the notification object.

13. The digital television of claim 12, wherein the notification service is a program run as a background process by the digital television interacting with applications executed by the digital television and digital television system components.

14. The digital television of claim 12, wherein notification clients include applications executed by the digital television and digital television system components.

15. The digital television of claim 12, wherein one or more notification clients includes a cloud service configured to push notifications to the digital television by way of a communications network.

16. The digital television of claim 12, wherein the notification object includes a display message for one or more of a message notification, content alert, system update, system requirement, menu element presentation and display element in general of the digital television.

17. The digital television of claim 12, wherein the notifications service monitors changes in the layout, presentation, input and content of a display of the digital television the notification controller issues a query to the notifications client for relevant notification objects based on the changes.

18. The digital television of claim 12, wherein presentation of the notification object includes display of a toast element by the digital television.

19. The digital television of claim 12, wherein presentation of the notification object includes display of a menu element within a menu presented by the digital television.

20. The digital television of claim 12, further comprising receiving one or more values associated with the presentation configuration of the digital television by the notification controller and outputting the population command based on the one or more values associated with the presentation configuration of the digital television.

21. The digital television of claim 12, further comprising receiving ticks from a timer service of the digital television for timed presentation of the notification.

22. The digital television of claim 20, further comprising obtaining one or more notification objects from a notification database based on ticks received from the timer service and values associated with the presentation configuration of the digital television.

23. A method for presentation of notifications by a digital television, the method comprising:
running, by a digital television, a notifications service, wherein the notification service provides architecture for exchange and encapsulation of notification objects with respect to applications and components of the digital television;
receiving, by the notification controller, a notification object from a notifications client, wherein the notification object includes data for implementation of the notification and content of the notification object;
presenting, by the digital television, the notification object based on the data for implementation and the content of the notification object;
detection, by the digital television, selection of the notification object; and
transmitting, by the digital television, an indication of the selection of the notification to a cloud server.

24. The method of claim 23, wherein the indication of the selection of the notification is transmitted with a format of a notification object to the cloud server.

25. The method of claim 23, further comprising querying by a notifications controller of the notifications service one or more notification clients and outputting, by the notification controller, a population command for the notification object.
